(19) United States
(12) Patent Application Publication
(10) Pub. No.: US 2026/0159089 A1
(43) Pub. Date: Jun. 11, 2026

(54) METHODS AND APPARATUS FOR OPERATING A VEHICLE IN A LOW TRACTION ENVIRONMENT

(71) Applicant: Ford Global Technologies, LLC, Dearborn, MI (US)

(72) Inventors: Alexander Hoerdemann, Aachen (DE); Florian Rath, Pulheim (DE); Simon Baales, Köln (DE); Uwe Hoffmann, Leverkusen (DE); Felix Weinreich, Dortmund (DE)

(21) Appl. No.: 19/374,734

(22) Filed: Oct. 30, 2025

(30) Foreign Application Priority Data
Dec. 6, 2024 (DE) 102024136522.6

(51) Int. Cl. B60W 30/18; B60W 10/20; B60W 10/22; B60W 50/14

(52) U.S. Cl. CPC B60W 30/18172; B60W 10/20; B60W 10/22; B60W 2050/146; B60W 2520/105; B60W 2552/05; B60W 2710/207; B60W 2710/22; B60W 2720/26

(57) ABSTRACT

The disclosure generally relates to vehicles and more particularly to, methods and apparatus for operating a vehicle in a low traction environment. An example vehicle includes an active suspension system, an electric steering system, and a controller configured to determine a wheel slip of at least one road wheel of the vehicle, and in response to the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

### RELATED APPLICATION

This patent claims priority from DE Patent Application Number 102024136522.6, which was filed on Dec. 6, 2024, and is hereby incorporated by reference in its entirety.

### FIELD OF THE DISCLOSURE

The disclosure generally relates to vehicles and more particularly to, methods and apparatus for operating a vehicle in a low traction environment.

### BACKGROUND

Vehicles often operate in low traction environments such as off-road environments. Off-road environments include obstacles or terrain through which it is difficult for vehicles to maneuver effectively. For example, mud, ruts, snow or sand, can cause a traction of the vehicle to be reduced.

### BRIEF DESCRIPTION OF THE DRAWINGS

FIG. 1 shows a schematic representation of a vehicle including an assembly according to examples described herein.

FIG. 2 shows a schematic representation of the vehicle of FIG. 1 with an alternative assembly according to examples described herein.

FIG. 3 shows a schematic representation of an example method for operating an assembly according to examples described herein.

FIG. 4A and FIG. 4B show schematic representations of an increase in length of a spring device.

FIG. 5 shows a schematic representation of alternating rotational movements of a steerable road wheel.

FIG. 6 shows a schematic representation of alternating rotational movements of a pair of steerable road wheels.

FIGS. 7A and 7B show schematic representations of toe-in and toe-out positions of steerable road wheels.

FIG. 8 is a block diagram of an example programmable circuitry platform 800 structured to execute and/or instantiate the example machine-readable instructions and/or the example operations of FIG. 3 to implement examples disclosed herein.

### SUMMARY

An example vehicle comprising an active suspension system, an electric steering system, and a controller configured to determine a wheel slip of at least one road wheel of the vehicle, and in response to the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

An example non-transitory machine readable storage medium comprising instructions to cause programmable circuitry to at least determine a wheel slip of at least one road wheel of a vehicle, and based on the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

An example method comprising determining a wheel slip of at least one road wheel of a vehicle, and based on the wheel slip exceeding a wheel slip threshold, causing a first road wheel of the vehicle to assume a toe-in position relative to a track position of the vehicle, and causing a second road wheel of the vehicle to assume a toe-out position relative to the track position of the vehicle.

### DETAILED DESCRIPTION

Vehicles are often used in off-road environments. When vehicles are driven off-road, for example through deep mud, ruts and/or deep snow or sand, traction of the vehicle may be reduced. As a result, the vehicle may lose momentum or become stuck. Such situations can occur, for example, if the tire tread has been filled with mud or snow, or if the ground clearance is too low, so that the underbody of the vehicle touches the ground, which reduces tire contact and thus the traction of the tires.

Experienced off-road drivers counteract or prevent the scenarios described above by raising an adaptive suspension of the vehicle as high as possible, therefore increasing ground clearance. In some examples, experienced off-road drivers make small oscillating steering inputs around the intended steering input. The oscillating rotational movements of the road wheels provide more traction as the vehicle tires and sidewalls rub against the ruts in which the vehicle sits. In this way, tire traction can be increased and the vehicle can continue to move. However, these approaches are based on manual adjustments to the steering input by experienced off-road drivers and a large portion of vehicle drivers are unaware of these methods of adjustment to vehicle parameters and steering input.

There is therefore a need to eliminate or at least reduce the disadvantages of known processes and assemblies for the operation of a vehicle in an off-road environment. The problems described above are solved or at least reduced by the examples described herein. Some examples described herein relate to a method for operating an assembly of a vehicle. The assembly includes an active suspension system and/or an electromechanical steering system. The active suspension system includes at least one suspension device that can be adjusted in length during operation of the vehicle. The steering system may be an electromechanical steering system that includes at least one road wheel actuator. The vehicle includes at least one control device (e.g., electronic control unit (ECU)) coupled with the active suspension system and/or the electromechanical steering system. An example method includes at least the following operations. First, at least one wheel slip is determined for at least one road wheel of the vehicle. If the determined wheel slip exceeds a first slip threshold, a length of at least one length-adjustable spring device of the active suspension system is increased, and/or at least one steerable road wheel coupled to the road wheel actuator of the electromechanical steering system performs alternating rotational movements around a wheel steering axle, and/or a first steerable road wheel coupled to a first road wheel actuator assumes a toe-in position with respect to a track position of the vehicle specified by a steering input and a second steerable road wheel coupled with a second road wheel actuator adopts a toe-out position.

The example method is based on the knowledge that a number of measures can be used to enable an increase in traction of the vehicle. By increasing the length of the spring device, the ground clearance of the vehicle is increased. As a result, the underbody of the vehicle does not contact uneven surfaces so that traction is not reduced. Depending on the height of the uneven ground, this leads to an increase in traction. Due to the rotational movements of the steerable road wheel, sidewalls of the road wheel tires are pressed against the walls of the ruts in which the vehicle is located. This also leads to an increase in traction. Due to the deliberate deflection of one road wheel according to a toe-in position, the orientation of the steerable road wheel deviates from the track position specified by the steering input. The other road wheel deviates relative to the specified track position in accordance with a toe-out position. The fact that a first steerable road wheel occupies a toe-in position and the second steerable road wheel adopts a toe-out position allows the divergences caused by the toe-in position and the toe-out position relative to the specified toe-in position to compensate for each other. With two wheel actuators, the steerable road wheels are steered synchronously into the toe-in position and the toe-out position. One wheel is turned less than the set steering angle and the other is turned the same or more than the set steering angle. Accordingly, the steerable road wheels work together in such a way that the vehicle continues to follow the specified track position. As a result, traction can be increased, as the toe-in position and the toe-out position allow at least tire sidewalls to contact portions of the ground, such as walls of ruts.

The measures to increase traction can be carried out in accordance with the example or by the example control device automatically. For example, the vehicle can have a specific operating mode (e.g., an off-road mode), which enables even inexperienced drivers to prevent the vehicle from getting stuck or to free themselves from a stuck driving condition. Although experienced drivers may be aware of the various measures to increase traction, the method eliminates the need for drivers to perform these measures manually. As a result, the vehicle's ability to move on uneven terrain (e.g., off-road terrain) increased.

According to a further aspect, some examples described herein relate to an assembly for the operation of a vehicle. The assembly includes at least one control device and an active suspension system and/or an electromechanical steering system. The active suspension system includes at least one suspension device that can be adjusted in length during operation of the vehicle. The electromechanical steering system includes at least one road wheel actuator. The control device is at least coupled with the active suspension system and/or the electromechanical steering system. The regulation device is at least configured to determine at least one wheel slip for at least one road wheel of the vehicle, and provided that the determined wheel slip exceeds a first slip threshold value, cause an increase to a length of at least one length-adjustable spring device, and/or cause alternating rotational movements of at least one steerable road wheel around a wheel steering axle, and/or cause a first steerable road wheel coupled to the road wheel actuator to assume a toe-in position and cause a second steerable road wheel coupled with an additional road wheel actuator to assume a toe-out position. The advantages achieved by the method described herein are also achieved in a corresponding manner by the assembly.

An active suspension system can be understood as a suspension system that includes at least one spring device whose effective spring travel can be adjusted during operation. This is achieved by varying the overall height of the suspension device, so that a translation of at least one road wheel is ensured. The suspension device may be configured to vary the overall height of the suspension device via static forces and/or by dynamically varying forces, for example via a pump. The spring device can be a mechanical spring device, a pneumatic spring device, or a hydraulic spring device. In some examples, the active suspension system for adjusting the length of the spring device includes at least one actuator. The actuator can also be part of the spring device itself, for example if it is a piston.

The electromechanical steering system can be understood in particular as a steer-by-wire (SBW) steering system. For the electromechanical steering system, the direct mechanical connection between the steering wheel and the road wheel is eliminated and replaced by two actuators, a steering wheel actuator with feedback, which generates feedback torque for the driver (e.g., on the steering wheel), and a road wheel actuator, which regulates the road wheels to the desired position. At the steering wheel, the driver is given feedback about the vehicle's lateral control based on the feedback torque. To do this, the control device determines a feedback torque and causes the steering wheel actuator to apply the feedback torque to the steering wheel.

In some examples, the control device determines the feedback torque at least based on a steering variable of the steerable road wheels of the steering system. The feedback torque is determined so to compensate for the alternating rotational movements and/or toe-in positions and toe-out positions of the steerable road wheels are compensated. For example, the determined feedback torque can depend on the position of a steering rack and/or on a driver's steering angle of at least one steerable road wheel. Because the driver's steering angle is the reference direction for the alternating rotational movements and/or toe-in positions and toe-out positions, this results in uniform feedback being provided at the steering wheel without the feedback torque being subject to the variances caused by the alternating rotational movements and/or toe-in positions and toe-out positions. As a result, the steering feel for the driver is even, ensuring a high level of comfort. In other words, the oscillating steering movements of the road wheels, or the dynamically changed track setting in the case of wheel-individually adjustable road wheel actuators, are not returned to the driver by the steering wheel. This means that the driver keeps the steering wheel constantly in a predetermined steering direction, while the road wheels assume the alternating rotational movements and/or out-of-lane positions described above to improve traction.

The electromechanical steering system of the vehicle is to be understood as the conventional electromechanical steering system of the vehicle, but not auxiliary steering, which is only made possible by torque control with regard to drive units (e.g., motors) and/or deceleration (e.g., brakes) devices assigned to the respective road wheels. In this context, the drive units are to be understood as correspondingly operated electric motors, each of which is assigned to at least one road wheel and serves to drive the vehicle, but not to guide the vehicle laterally. Rather, the drive units are separate from the road wheel actuators and their electric motors. The electromechanical steering system includes at least one road wheel actuator coupled to at least one steerable road wheel. In some examples, the road wheel actuator can also be coupled at the same time, at least indirectly, with several steerable road wheels, for example via a rack. In some examples, the vehicle may include several road wheel actuators, each individually coupled with several steerable road wheels. In some examples, the vehicle may also include separate individual road wheel actuators with regard to at least some of the motor vehicle's steerable road wheels. This means that the corresponding steerable road wheels can be controlled independently of other steerable road wheels for the lateral guidance of the vehicle according to individual wheel orientations. This makes it possible, for example, for individual steerable road wheels to have different orientations, for example a toe-in position or a toe-out position with respect to a track position defined by the driver's steering input. In some examples, the lateral control of the vehicle can be based on steering inputs given by the driver, for example via the steering wheel to steer the vehicle in a specific direction.

Wheel slip refers to the divergence of the wheel tread according to the wheel speed from the driving surface with which the respective wheel is in frictional contact, whereby a tangential force counteracts the traction. Traction means the transfer of the tractive force to drive the vehicle relative to the ground. A certain amount of wheel slip occurs when the vehicle is powered, for example depending on the surface conditions and the type of tire. However, if the wheel slip becomes too large, the vehicle can no longer be guided precisely, measured by the driver's steering input. In some examples, a first slip threshold value is calculated that indicates whether a prevention measure by the control device is necessary. In other words, the first slip threshold indicates when loss of traction exceeds a threshold so that it can be counteracted by the control device.

Alternating rotational movements are to be understood here as the steerable road wheels repeatedly executing rotational movements around the steering axle. In this context, the toe-in position or the toe-out position is to be understood as meaning that the steerable road wheel assumes an orientation relative to the steering axle in such a way that it deliberately diverges from a track position of the vehicle. In general, toe-in positions and toe-out positions are only defined when the steerable road wheels are positioned in a straight line. In this context, the toe-in positions and toe-out positions explained here are intentionally divergent positions of the steerable road wheels, which are also used during a steering operation. The track position of the vehicle corresponds to an alignment of the steerable road wheels according to the driver's steering input. The lane position indicates the direction in which the driver wants to steer the vehicle. Based on the toe-in position, the steerable road wheel artificially deviates from this orientation, corresponding to a larger steering angle than desired by the driver. Accordingly, the steerable road wheel also artificially deviates from this alignment based on the toe-in position, and indeed according to a smaller steering angle than desired by the driver. If, for example, the track position were to indicate a straight alignment of the motor vehicle along the longitudinal axis of the vehicle in accordance with the driver's steering input, the steerable road wheel would be at least partially rotated around the steering axle in accordance with the toe-in position or the toe-out position and would have an orientation that diverges from the straight alignment. The toe-in position and the toe-out position correspond to orientations on opposite sides of the reference direction, which is defined by the lane position based on the driver's steering input.

In some examples, the first slip threshold value is variable based on at least one vehicle speed and on speed change values of the vehicle and is determined by the control device based on at least these parameters. As mentioned, a certain amount of slippage occurs on the road wheels if the drive of the vehicle is used for propulsion. By considering the vehicle speed and the speed change values of the vehicle, the current driving condition can be considered to appropriately adjust the slip threshold value.

The vehicle speed here refers to the actual above-ground speed of the vehicle, which can diverge from the driver's input, for example via an accelerator pedal, due to a lack of traction or too much slippage. The actual vehicle speed can be determined, for example, by sensor data from the road wheels, by a position sensor, by speed change sensors or by yaw rate sensors. The speed change values here are to be understood as the speed change values of the vehicle corresponding to three vehicle axles orthogonally oriented to each other (e.g., along the vehicle's longitudinal axis, the vehicle transverse axis, and the steering axle).

In some examples, a speed sensor detects a speed for at least one road wheel of the vehicle and transmits the detected speed to the control device. The recorded speed can then be set in relation to the slip threshold value, which depends on the vehicle speed and the speed change values of the vehicle. This makes it possible to determine the actual slip for the corresponding road wheel of the motor vehicle. In some examples, several speed sensors can be provided for different road wheels of the vehicle. Similarly, the slippage of the respective road wheels of the vehicle can be compared with initial slip threshold values for each individual road wheel of the vehicle. When determining whether the determined wheel slip exceeds a first slip threshold value, an average over several road wheels or all road wheels can then be considered. In an alternative example, it may be decisive that the determined wheel slip exceeds the first slip threshold value only for a single road wheel of the vehicle.

In some examples, the control device also compares a current chassis position of a vehicle chassis with a nominal chassis position of the vehicle chassis and considers the comparison when adjusting the active suspension system. For example, the current suspension position of the chassis may have been adjusted due to a lowering or raising of the chassis by the user and therefore no longer corresponds to the nominal chassis position. In addition, a divergence between the current chassis position and the nominal chassis position may be caused by unevenness of the ground. Regarding the nominal chassis position, the control device can consider the possible adjustment range of the length-adjustable spring devices. The comparison then makes it possible to determine whether the possible adjustment range of the spring device allows an increase in the length of the spring device. For example, the spring device can already be maximally adjusted for height. In such examples, other measures must be taken to increase traction.

In some examples, the control device can also take into account several or all of the actual lengths of the adjustable spring devices at any given time. If at least one length-adjustable spring device does not already have the maximum length, the corresponding suspension control signal can then cause an increase in the length of the corresponding spring device. In some examples, the control device can also regulate the active suspension system in such a way that the length of several length-adjustable spring devices of the vehicle is increased at the same time. This increases the ground clearance below the underbody of the vehicle not only selectively, but overall.

In some examples, the control device executes the method if the control device determines, based on environmental sensor data and/or position data, that the vehicle is in an off-road environment and/or that the vehicle is stuck. The environmental sensor data can be recorded, for example, using camera sensors, radar sensors, lidar sensors and/or infrared sensors. The environmental sensor data allows the control device to identify an off-road environment in the vicinity of the motor vehicle. The position data can be received using a position signal receiver that is configured to receive a position signal from a global navigation satellite system. Based on the received position signal, the position of the vehicle can be determined by the position signal receiver or the control device. By comparing the actual position of the vehicle with corresponding topographical map material, the control device can then determine that the vehicle is in an off-road environment. In some examples, the control device executes the method when it receives a user input to execute the method. This allows the driver of the vehicle to manually trigger the appropriate procedure if desired, thus increasing comfort for the driver.

In some examples, after the method has been executed, a notification is also issued to the driver by the control device via an output device. This informs the driver of the vehicle that the control device influences the suspension behavior of the active suspension system and/or the steering behavior of the electromechanical steering system to increase traction. For example, it can prevent a driver, unaware of the influence of the control device, from counteracting the alternating rotational movements of the steerable road wheel.

In some examples, the alternating rotational movements of the steerable road wheel are smaller than a calibratable rotation angle interval around the wheel steering axle. This allows the alternating rotational movements to be limited to a level acceptable to the driver of the vehicle. In some examples, the rotation angle interval can be adjusted by user input via an input device by the driver. In some examples, the duration of the alternating rotational movements of the steerable road wheel is shorter than a specified period threshold. This can prevent the alternating rotational movements from being carried out too slowly. Otherwise, a slow execution of the alternating rotational movements could lead to a counteraction on the part of the driver against the alternating rotational movements. The period threshold value can preferably be specified by the control device. For example, the period threshold can depend on the speed of the vehicle. This allows the speed of the alternating rotational movements to be matched to the vehicle speed to increase traction in an appropriate way.

In some examples, a reference direction of the alternating rotational movements of the steerable road wheel corresponds to a default direction defined by a steering input of the driver. The reference direction of the alternating rotational motions here is to be understood as the center direction around which the alternating rotational motions occur in different directions. To ensure that the vehicle is steered in accordance with the driver's steering input despite the method, the reference direction is defined by the driver's steering input (e.g., the steering angle of the steering wheel and the steering wheel speed). The alternating rotational movements are then carried out around the reference direction based on the rotation signal.

In some examples, the alternating rotational movements have a sinusoidal course with respect to the reference direction. This means that the alternating rotational motions have a relatively small angular change per unit of time while the angular change in the area of passage through the reference direction is relatively large per unit of time. This ensures that the tire sidewalls are in contact with portions of the ground, such as the walls of ruts, for as long as possible. In contrast, the passage through the reference direction corresponds to an alignment of the steerable road wheel, in which it must be assumed that no part of the tire, in particular not the tire sidewall, is in contact with a part of the ground, in particular walls of ruts, which is why the alternating rotational movements occur particularly quickly at that time. In some examples, a distorted sinusoidal profile is applied for the course of the alternating rotational movements, in which the reversal points are flattened and the zero crossing is chosen steeper to extend the contact time of the tire sidewalls with portions of the ground.

In some examples, the first steerable road wheel coupled to the road wheel actuator and the second steerable road wheel coupled to the additional road wheel actuator carry out corresponding alternating rotational movements around a respective steering axle with regard to the track position of the vehicle specified by the steering input. This means that both road wheels perform rotational movements around the respective steering axle. The rotational movements are such that they compensate for each other regarding the steering axle. In this way, the vehicle can be guided along the steering input despite the alternating, dynamic rotational movements, while still increasing traction.

In some examples, the control device stops the output of the suspension control signal and/or the rotation control signal and/or the lane control signal if the determined wheel slip does not exceed a second slip threshold value for a specified number of control intervals within a predetermined period. This allows the control device to determine whether the vehicle has sufficient traction again. As a result, the influence on the active suspension system or the electromechanical steering system can be terminated. In this way, regular driving comfort can be regained in an automated manner. In some examples, the control device stops the output of the suspension control signal and/or the rotation control signal and/or the lane control signal if a vehicle speed is greater than a speed threshold. At sufficiently high vehicle speeds, it can be assumed that there is sufficient traction. The speed threshold is used to determine whether the influence of the control device can be terminated. In some examples, the first slip threshold and the second slip threshold are different. This ensures hysteresis between the slip threshold values, so that fluctuating control behavior of the control device is prevented.

In some examples, the method is configured as a computer-implemented method. This means that the operations can be carried out with the help of one or more data processing devices. For example, a data processing device of the control device can trigger or perform the corresponding operations. The active suspension system and/or the electromechanical steering system, such as the road wheel actuator, may also include their own control devices with corresponding data processing devices, which are used, at least indirectly, to bring about the corresponding effects of the suspension control signal, the rotation control signal, and/or the lane positioning signal. In such examples, the control device of the assembly can be regarded as a vehicle control device that outputs the appropriate control signals to the components. The actual actuation of the individual components, for example a length adjustment of the length-adjustable spring device, can then be affected by a control device of the sub-assembly.

According to a further aspect, the disclosure also relates to a computer program product, including instructions which, when executed by a computer, cause the computer to execute the method as described herein. The benefits achieved by the method described herein are also achieved in a corresponding manner by the computer program product. According to an additional aspect, the disclosure also relates to a non-transitory computer-readable storage medium, comprising commands which, when executed by a computer, cause the computer to execute the method as described herein. The advantages achieved by the process described herein are also achieved in a corresponding way by the non-transitory computer-readable storage medium. According to a further aspect, the disclosure also relates to a vehicle having an assembly as described herein or with an assembly which is operable by a method as described herein. The advantages achieved by the method described herein are also achieved in a corresponding manner by the vehicle.

For the purposes of the disclosure, vehicles may include land vehicles, namely, inter alia, off-road and road vehicles such as passenger cars, buses, trucks and other commercial vehicles. Vehicles can be manned or unmanned. Vehicles can be at least partially electrically driven, have an internal combustion engine and/or an electric motor that serves as propulsion.

All the features explained regarding the various aspects can be combined individually or in (sub-)combination with other aspects. The detailed description below, in conjunction with the accompanying drawings, in which the same numbers refer to the same elements, is intended as a description of different examples of the disclosed object and is not intended to represent the only examples. Each example described in this disclosure is intended only as an example or illustration and should not be construed as favored or advantageous over other examples. The illustrative examples contained herein do not claim to be exhaustive and do not limit the claimed subject-matter to the exact disclosed forms. Various variations of the examples described are readily recognizable to the skilled person and the general principles defined herein can be applied to other examples and applications without departing from the spirit and scope of the examples described. Therefore, the examples described are not limited to the examples shown but have the widest possible scope of application that is compatible with the principles and characteristics disclosed here. All the features disclosed below in relation to the examples and/or accompanying figures may be combined, alone or in any sub-combination, with features of the aspects of disclosure provided that the resulting combination of features is reasonable to a skilled person in the field of technology.

For the purposes of disclosure, the phrase “at least one of A, B and C” means, for example, (A), (B), (C), (A and B), (A and C), (B and C) or (A, B and C), including all other possible combinations if more than three elements are listed. In other words, the term “at least one of A and B” generally means “A and/or B”, namely “A” alone, “B” alone or “A and B”.

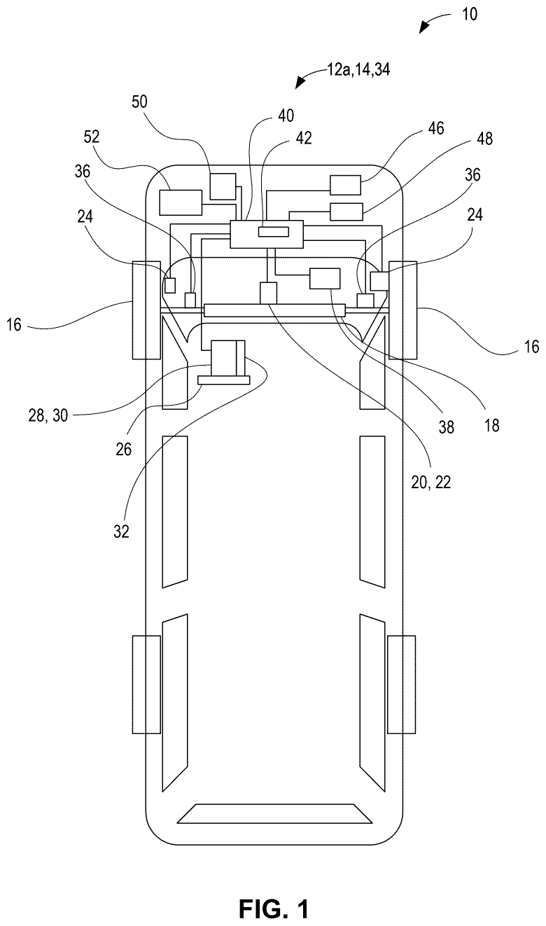

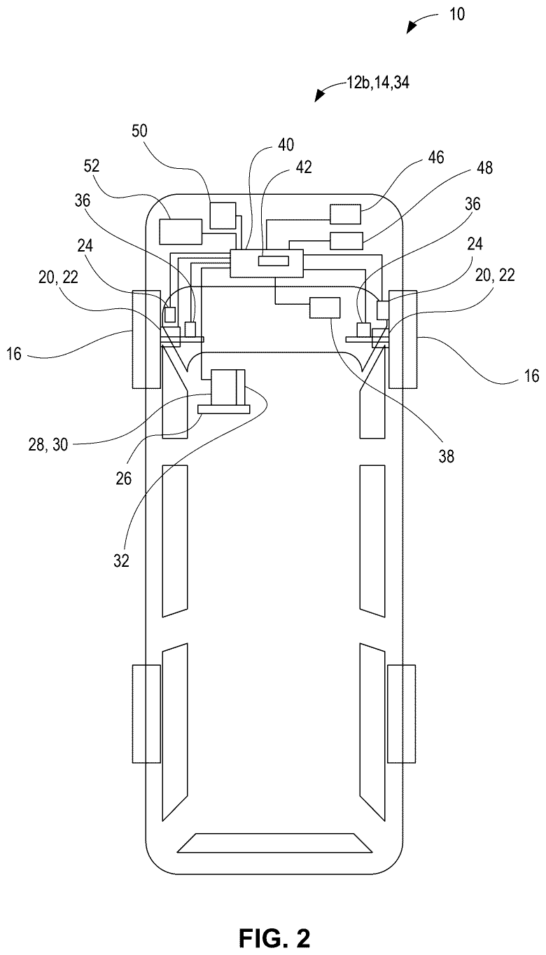

FIG. 1 shows a schematic representation of a vehicle 10 with an example assembly 12a. FIG. 2 shows a schematic representation of the motor vehicle 10 with an alternative assembly 12b according.

In the illustrated example of FIG. 1, the assembly 12a of motor vehicle 10 includes an electromechanical steering system 14 with steerable road wheels 16. The steerable road wheels 16 are coupled to a common rack 18. The common rack 18 can be moved from a reference position, for example a zero position, which causes a steering movement of the steerable road wheels 16. For example, the steerable road wheels 16 can be deflected starting from a straight alignment of the vehicle 10 so that the vehicle 10 performs a curve.

For the movement of the rack 18, the electromechanical steering system 14 includes a single road wheel actuator 20 that can jointly influence the alignment of both steerable road wheels 16 of the vehicle 10. In the illustrated example, the road wheel actuator 20 is coupled with the rack 18. In some examples, the road wheel actuator 20 can also be coupled to the steerable road wheels 16 in other ways to be able to influence their orientation.

In contrast to the example of FIG. 1, the example illustrated in FIG. 2 differs in that the respective road wheel actuators 20 are individually coupled with the steerable road wheels 16. As a result, rack 18 can be omitted. This makes it possible to effect wheel-specific alignments of the steerable road wheels 16 independently of other steerable road wheels 16.

Even if not shown in the examples of FIG. 1 and FIG. 2, the vehicle 10, assemblies 12a, 12b and the electromechanical steering system 14 may also include other steerable road wheels 16, for example rear wheels, which are coupled with an additional common road wheel actuator 20 or with individual road wheel actuators 20.

Each road wheel actuator 20 includes an electric motor 22. The electric motor 22 includes at least one winding set that has a group of windings. Each winding set is configured so that phase currents can be used to drive a rotor of the electric motor 22. The rotor can then be coupled with a corresponding component of the electromechanical steering system 14, such as the rack 18, and thus enable the movement of the steerable road wheels 16. In general, the electric motor 22 can also include more than one winding set. Typically, each winding set is three-phase, so that the electric motor 22 is configured as at least three-phase, optionally also six-phase or nine-phase. If there are several winding sets, the winding sets allow the rotor of the electric motor 22 to move independently of other winding sets.

The assembly 12b also includes speed sensors 24 as part of the electromechanical steering system 14. The speed sensors 24 are coupled with road wheels 16 and are configured to detect a speed of the road wheels 16 in the circumferential direction.

The electromechanical steering system 14 of motor vehicle 10 also includes a steering wheel 26. Using the steering wheel 26, a driver of the motor vehicle 10 can provide steering inputs to the vehicle 10 to steer the vehicle 10 in a desired direction.

A steering wheel actuator 28 of the electromechanical steering system 14 is coupled to the steering wheel 26. The steering wheel actuator 28 includes an electric motor 30. The electric motor 30 of the steering wheel actuator 28 also includes at least one winding set. Each electric motor 30 winding set is three-phase and configured to drive an electric motor rotor. As a result, feedback torque can be provided to the driver via the steering wheel 26 of the vehicle 10 by the electric motor 30 to give the driver feedback about the lateral control of motor vehicle 10.

The electromechanical steering system 14 also includes at least one steering wheel sensor 32, which is coupled with the steering wheel 26. Each steering wheel sensor 32 is configured independently of other steering wheel sensors 32 to detect a driver's steering preset based on a steering wheel angle and/or steering wheel speed of the steering wheel 26 compared to a reference position.

The assemblies 12a, 12b also include an active suspension system 34. The active suspension system 34 includes at least two length-adjustable spring devices 36 in accordance with the examples of FIG. 1 and FIG. 2.

One longitudinal extension direction of the length-adjustable spring device 36 is aligned parallel to the steering axle. The length-adjustable spring devices 36 include a component, for example a piston, so that a total length of the length-adjustable spring devices 36 can be variably adjusted along their longitudinal extension direction during operation. In general, the length-adjustable spring devices 36 are arranged and configured in such a way that uneven ground on which the vehicle 10 travels can be at least partially compensated.

The active suspension system 34 also includes a suspension sensor 38, which is configured to detect an actual position of a part of the chassis, such as a part of a length-adjustable spring device 36 in relation to a reference position. Without uneven ground, the chassis of the vehicle 10 should have a nominal chassis position. Due to an adjustment of the lengths of the adjustable spring devices 36 or due to unevenness in the ground, divergences may occur between the actual chassis position and the nominal chassis position. These divergences can be detected using the chassis sensor 38. In some examples, the active suspension system 34 can include several chassis sensors 38.

The assemblies 12a, 12b also includes a control device 40 with a data processing device 42. In general, the control device 40 can also be a control device of the electromechanical steering system 14 and/or the active suspension system 34. The control device 40 is at least indirectly coupled with the road wheel actuators 20, the speed sensors 24, the steering wheel actuator 28, the steering wheel sensor 32, the adjustable spring devices 36 and the chassis sensor 38.

In addition, the assemblies 12a, 12b include at least one position signal receiver 46, a speed and speed change sensor 48, an environmental sensor 50, and a user interface 52, all of which are at least indirectly coupled with the control device 40. Via the position signal receiver 46, a position signal from a global navigation satellite system can be received, so that the control device 40 can determine the position of the vehicle 10 based on the received position signal. The velocity and velocity change sensor 48 is configured to detect an above ground velocity and to transmit to the control device 40 an above ground speed and velocity change values of the vehicle 10 corresponding to three orthogonally oriented axes, for example the steering axle, the vehicle longitudinal axis and the vehicle transverse axis.

The environmental sensor 50 can include at least one of a camera, a radar, a LIDAR and an infrared sensor. The environmental sensor 50 transmits the acquired environmental sensor data to the control device 40, which can determine whether the vehicle 10 is in an off-road environment based on the received environmental sensor data.

The user interface 52 can be used to issue notifications from the control device 40 to a driver of the vehicle 10 or to receive user input from the vehicle user from the control device 40. For example, user interface 52 can be configured as a multimedia display.

The control device 40 is shown here as part of the assemblies 12a, 12b. In some examples, the control device 40 can also adopt control mechanisms of the electromechanical steering system 14 and/or the active suspension system 34. The electromechanical steering system 14 and/or the active suspension system 34 can also include several components of the same type and generally the same function, thus ensuring redundancy.

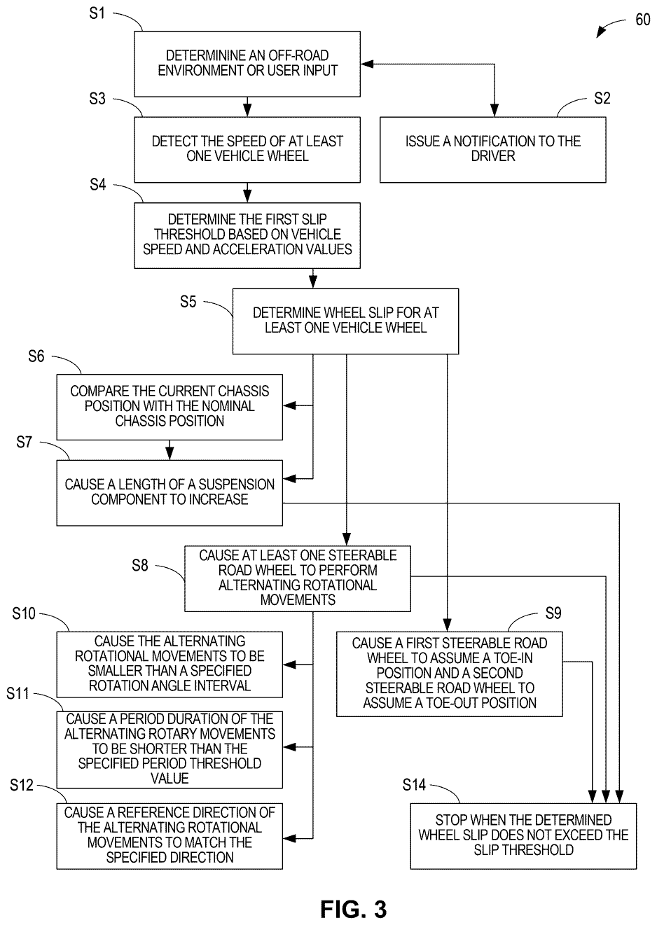

FIG. 3 shows a schematic representation of a method 60 for the operation of an assembly. Optional operations are shown in dashed form. According to the optional operation S1, the method 60 is triggered at least when the control device 40 determines that the vehicle 10 is in an off-road environment and/or that the vehicle 10 is stuck, based on environmental sensor data. In some examples, the triggering of the method 60 can be based on the control device 40 receiving a user input to trigger the method 60.

The environmental sensor data can be recorded using the environmental sensor 50 and transmitted to the control device 40. The position data can be received via the position signal receiver 46 and transmitted to the control device 40. In this respect, the control device 40 is equipped for the evaluation of the environmental sensor data and/or the position signal received by the position signal receiver 46. For example, the control device 40 can compare the detected position of the vehicle 10 with topographic map data to determine an environmental condition around the vehicle 10. A corresponding user input for the triggering of the method 60 can be made, for example, using user interface 52.

If the method 60 is triggered, a notification is also issued to the driver by the control device 40 via an output device relating to the triggered method 60 in accordance with the optional operation S2. For example, the output device can be part of the user interface 52. In this way, the driver of the vehicle 10 can be made aware that the control device 40 will take measures to increase traction.

In the following optional operation S3, a speed for at least one road wheel 16 of the vehicle 10 is recorded and transmitted to the control device 40. For example, a corresponding speed sensor 24 can be used for this purpose.

The method 60 then includes the optional operation S4, in which the control device 40 determines the first slip threshold based on at least one vehicle speed and/or based on the vehicle 10 speed change values for the vehicle configuration present at a specific point in time. The control device 40 can use the speed and speed change sensor 48 for this purpose, which can record corresponding measured values regarding the vehicle speed and the speed change values of the vehicle 10.

The method 60 includes the subsequent operation S5, in which at least one wheel slip for at least one road wheel 16 of the vehicle 10 is determined by the control device 40. Measured values from the speed sensor 24 can also be used here. Due to the vehicle speed detected by the speed and speed change sensor 48 and the recorded speed change values, the control device 40 knows the speed at which the road wheel 16 under consideration should actually rotate. Considering the actual speed, the wheel slip for the road wheel 16 can therefore be determined.

The control device 40 then evaluates whether the determined wheel slip exceeds the first slip threshold value. Because the first slip threshold value is adapted to the respective vehicle configuration in terms of vehicle speed and speed change values, this evaluation is carried out specifically for a configuration at a given time.

If the determined wheel slip exceeds the first slip threshold value, at least one traction increase measure is triggered by the control device 40. The measures to increase traction are presented in the method 60 according to operations S7, S8 and S9. In general, any combination of the corresponding measures can be triggered by the control device 40.

In accordance with operation S7, the active suspension system 34 is subjected to a suspension actuator by the control device 40 in such a way that a length of at least one length-adjustable spring device 36 is increased. This increases the ground clearance below motor vehicle 10.

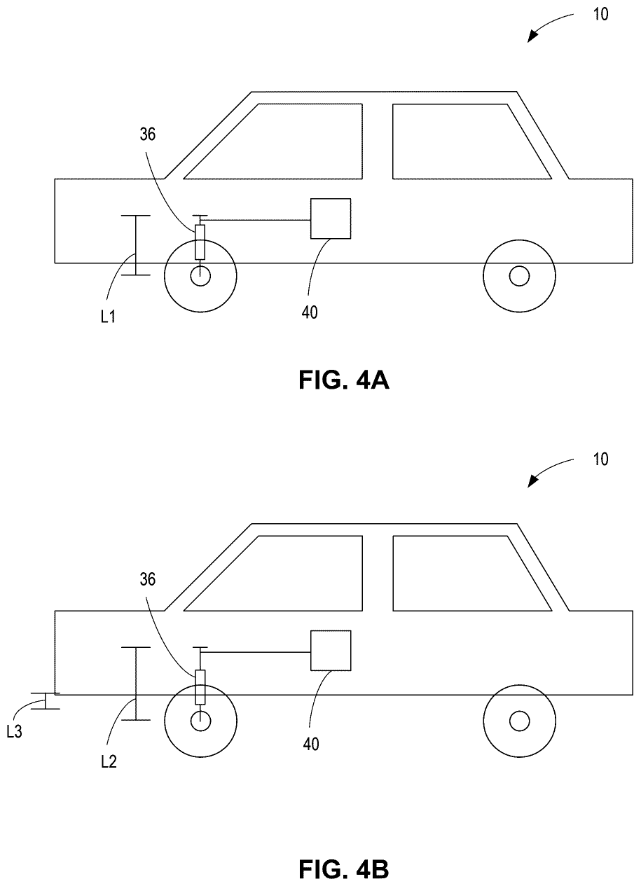

In the context of operation S7, FIG. 4A and FIG. 4B show schematic representations of an increase in the length of a spring device 36. According to the illustration in FIG. 4A, the length-adjustable spring device 36 has a first length L1. Via the corresponding suspension signal of the control device 40, an increase in the length of the spring device 36 can be brought about, which is shown in FIG. 4B. The spring device 36 now has an increased length L2, which is greater than the initial length L1, namely by the length difference L3. As a result, the ground clearance of the vehicle 10 is increased by the length difference L3 compared to the configuration of FIG. 4A by the measure corresponding to operation S7. This makes it less likely that a part of the vehicle 10 (e.g., other than the tread of the road wheels 16) would come into contact with the ground and then cause a loss of traction. This therefore indirectly leads to an increase in traction of the vehicle 10.

In operation S7, operation S6 can optionally be considered, in which the control device 40 additionally compares a current chassis position of a chassis of the motor vehicle 10 with a nominal chassis position and takes this comparison into account when applying a suspension control signal to the active suspension system 34. For comparison, the control device 40 may make use of the chassis sensor 38. This means that the control device 40 can know whether a further increase in the length of the adjustable spring device 36 is possible at all. In addition, the control device 40 can detect by comparing how much the actual chassis position diverges from the nominal chassis position. If the divergence is more pronounced, it can be assumed that this is due to uneven ground. This causes the control device 40 to increase the length of the adjustable spring devices 36. Corresponding threshold value conditions can be considered. For example, it may be necessary for the divergence between the actual chassis position and the nominal chassis position to exceed a differential threshold for a suspension actuator to be issued according to operation S7.

As an alternative or cumulative to operation S7, operation S8 can also be triggered by the control device 40. In operation S8, the electromechanical steering system 14 is pressurized with a rotation signal by the control device 40 in such a way that at least one steerable road wheel coupled with the road wheel actuator 20 performs 16 alternating rotational movements around a steering axis.

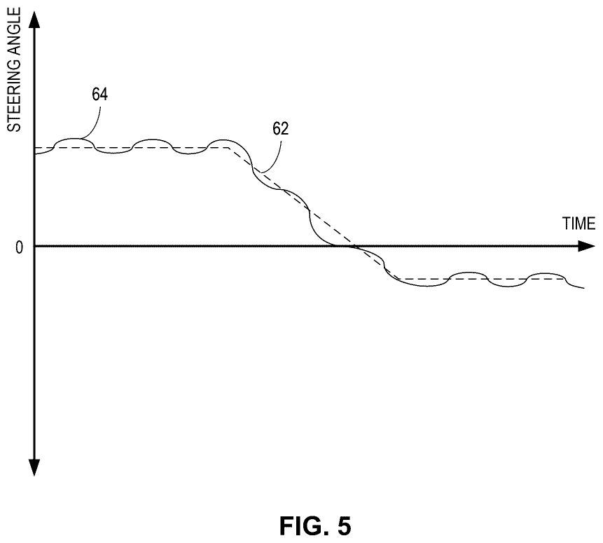

In the context of operation S8, FIG. 5 shows a schematic representation of alternating rotational movements of a steerable road wheel 16. On the y-axis, the steering angle is plotted compared to the time on the x-axis. According to the driver's steering input using the steering wheel 26, the result is a driver's steering angle 62 defined along which the vehicle 10 is to move. The rotary control signal now causes the steerable road wheels 16 influenced by the rotation control signal to perform alternating rotational movements around the driver's steering angle 62 corresponding to the resulting steering angle 64. The resulting steering angle 64 is adjusted in such a way that the vehicle 10 still follows the driver's steering angle 62 on average. According to this example, the resulting steering angle 64 has a sinusoidal progression around the driver's steering angle 62.

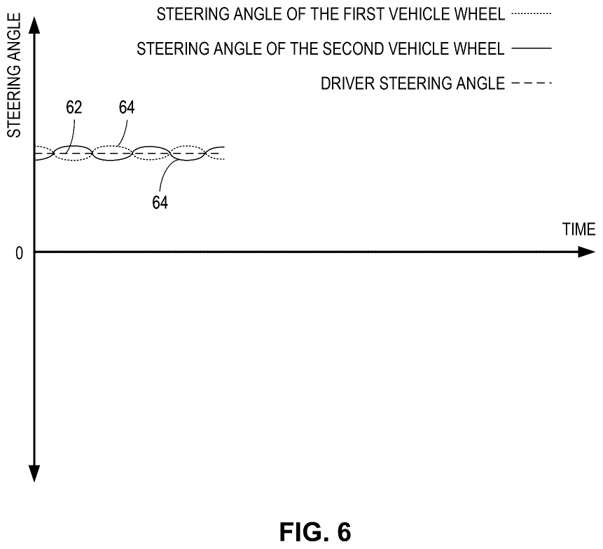

FIG. 6 a schematic representation of alternating rotational motions of a pair of steerable road wheels 16. On the y-axis, the steering angle is plotted compared to the time on the x-axis. Regarding the driver's steering angle 62, the steering angles 64 of the road wheels 16 of a pair, for example a front axle, resulting from the alternating rotational movements, are shown. The resulting steering angles 64 of the corresponding road wheels 16 are configured correspondingly to each other, so that the divergences from the driver's steering angle 62 compensate for each other.

As an alternative or cumulative to operation S7 and operation S8, operation S9 can also be triggered by the control device 40. In operation S9, the electromechanical steering system 14 is pressurized with a lane positioning signal by the control device 40 in such a way that a first steerable road wheel 16 coupled with the road wheel actuator 20 assumes a toe-in position with respect to a track position of the vehicle 10 specified by a steering input. In such examples, the electromechanical steering system 14 has an additional road wheel actuator 20 coupled to a second steerable road wheel 16. The lane position signal issued to the electromechanical steering system 14 is such that the second steerable road wheel 16 coupled with the additional road wheel actuator 20 assumes a toe-out position 68 with respect to the track position of the vehicle 10 specified by the steering input.

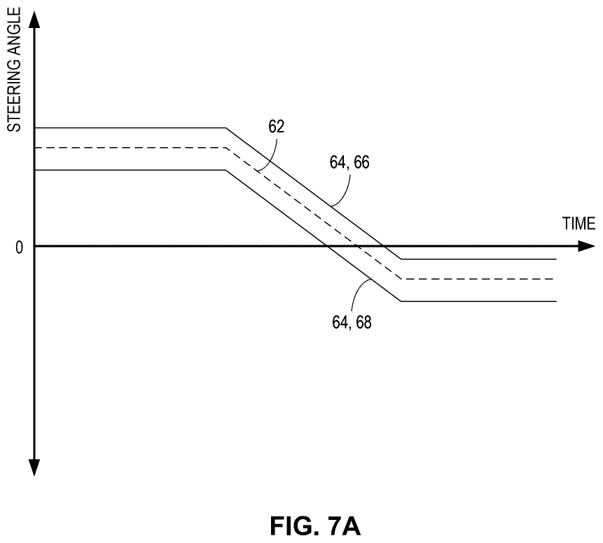

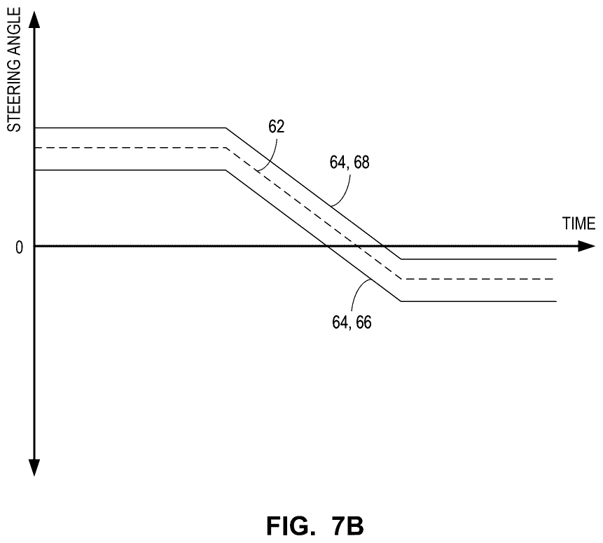

In the context of operation S9, FIGS. 7A and 7B show schematic representations of toe-in and toe-out positions of steerable road wheels 16. On the y-axis, the steering angle is plotted compared to the time on the x-axis. Again, the driver's steering angle 62 is shown, which is defined by the driver's steering input on the steering wheel 26, and which reflects the track position of the vehicle 10. The diagram in FIG. 7A shows the configuration of a static toe-in position, while the configuration in FIG. 7B shows the configuration of a static toe-out position. The toe-in position and the toe-out position always refer to the road wheel 16 on the outside of the curve.

In the static toe-in position, the resulting steering angle 64 of the road wheel 16 on the inside of the curve assumes an alignment in such a way that the alignment corresponding to the toe-in position 66 precedes the driver's steering angle 62 relative to the driver's steering angle 62. This means that the corresponding road wheel 16 steerable inside the curve has a larger rotation angle than would actually be necessary for the driver's steering angle 62.

In a correspondingly manner, a road wheel 16 that can be steered on the outside of the curve assumes an alignment in the static toe-out position 68 in such a way that the alignment corresponding to the toe-out position 68 lags behind the driver's steering angle 62 relative to the driver's steering angle 62. This means that the corresponding steerable road wheel 16 on the outside of the curve has a smaller rotation angle than would actually be necessary for the driver's steering angle 62. The toe-in position 66 of the road wheel 16 on the inside of the curve corresponds to the toe-in position of the road wheel 16 on the outside of the curve, so that the deviations from the driver's steering angle 62 are compensated for and the vehicle 10 is steered in accordance with the driver's steering angle 62.

When configuring the static toe-out position as shown in FIG. 7B, the relationships are reversed regarding the road wheel 16 on the inside and outside the curve and the toe-in position 66 and the toe-out position 68.

In the configuration shown in FIG. 6, the road wheels 16 simultaneously assume a toe-in position 66 or a toe-out position 68 with respect to the driver's steering angle 62. Both the alternating rotational movements and the toe-in position 66 and the toe-out position 68 cause the tire sidewalls of the steerable road wheels 16 to come into contact with parts of the ground, such as the walls of ruts, and thus directly increase the traction of the vehicle 10.

The method 60 can also be further implemented by the optional operation S10, in which the alternating rotational movements of the steerable road wheel 16 are smaller than a predetermined rotation angle interval around the steering axle. In particular, the rotation angle interval can be specified by the control device 40 or alternatively by user input using the user interface 52. The rotation angle interval represents a measure of alternating rotational movements acceptable to the driver of the vehicle 10.

In addition, the method 60 can also be further implemented by the optional operation S11, in which a period of the alternating rotational movements of the steerable road wheel 16 is shorter than a specified period threshold value. This causes the alternating rotational movements to occur according to a minimum speed. The period threshold can be specified by the control device 40, for example. For this purpose, the control device 40 may, for example, consider the vehicle speed and/or speed change values of the vehicle 10 so that the alternating rotational movements are adapted to the vehicle speed or the speed change values in terms of their speed.

Operation S12 can also be provided as an option, in which the driver's steering angle 62 of the alternating rotational movements of the steerable road wheel 16 corresponds to a default direction defined by a steering input of the driver. This has already been explained regarding FIG. 5. This ensures that, despite the alternating rotational movements, the vehicle 10 is still guided in accordance with the driver's steering input.

This has already been explained regarding FIG. 6. The toe-in position 66 and toe-out position 68, which are formed in opposite directions with regard to the driver's steering angle 62, compensate for the individual divergences caused individually by the toe-in position 66 and the toe-out position 68. The vehicle 10 is then still guided along the driver's steering angle 62 according to the specified lane position, which is defined by the driver's steering input. However, simultaneous toe-in positions 66 and toe-out positions 68 of individual steerable road wheels 16 require that the road wheels 16 can be steered individually by the steering wheel. For example, the example of assembly 12b from FIG. 2 can be used for this purpose, in which individual road wheel actuators 20 are assigned to the different steerable road wheels 16.

The method 60 may also include the optional operation S14. In accordance with operation S14, the control device 40 evaluates the determined wheel slip of the road wheel 16 regarding a second slip threshold value. The second slip threshold is different from the first slip threshold. The second slip threshold value may be specified by the control device 40, for example depending on the vehicle speed and/or the speed change values of the vehicle 10.

According to operation S14, the control device 40 stops the output of the suspension control signal and/or the rotation control signal and/or the lane control signal if the determined wheel slip does not exceed the second slip threshold value for a specified number of control intervals within a design period. In an alternative, the output of the corresponding control signals is terminated if a vehicle speed is greater than a speed threshold. In such examples, the control device 40 can in turn make use of the speed and speed change sensor 48. While falling below the second slip threshold indicates sufficient traction of the vehicle 10, which is why the method 60 can be terminated, it is desirable to prevent interference with the active suspension system 34 and/or the electromechanical steering system 14 if the speed of the vehicle 10 is too high to prevent instability.

The method 60 thus enables various measures to increase traction in challenging driving situations of the vehicle 10. For example, the active suspension system 34 and/or the electromechanical steering system 14 can be used for this purpose.

Example instructions and/or operations of FIG. 3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

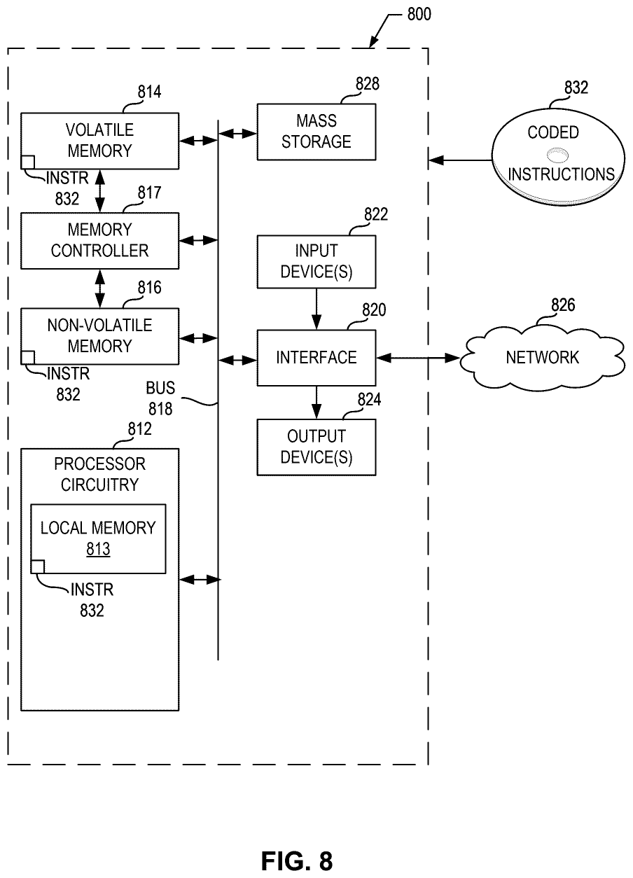

FIG. 8 is a block diagram of an example programmable circuitry platform 800 structured to execute and/or instantiate the example machine-readable instructions and/or the example operations of FIG. [Flowcharts] to implement examples disclosed herein. The programmable circuitry platform 800 can be, for example, a control device, an electronic control unit (ECU), a self-learning machine (e.g., a neural network), or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 812 may be implemented by one or more semiconductor based (e.g., silicon based) devices.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a button, a touchscreen, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 832, which may be implemented by the machine-readable instructions of FIG. [Flowcharts], may be stored in the mass storage device 828, in the volatile memory 814, in the non-volatile memory 816, and/or on at least one non-transitory computer readable storage medium such as a CD or DVD which may be removable.

This disclosure can refer to quantities and numbers. Unless expressly stated, such quantities and figures are not to be regarded as limiting, but as examples of the possible quantities or figures in connection with the disclosure. In this context, the term “plural” can also be used in Revelation to refer to a quantity or number. In this context, the term “plural” refers to any number that is greater than one, e.g. two, three, four, five, etc. The terms “approximately”, “approximately”, “near”, etc. mean plus or minus 5% of the stated value.

Although the disclosure has been presented and described in relation to one or more examples, after reading and understanding this description and the accompanying drawings, the skilled person will be able to make equivalent changes and modifications.

Methods and apparatus for operating a vehicle in a low traction environment are disclosed herein. Further examples and combinations thereof include the following:
Example 1 includes a vehicle comprising an active suspension system, an electric steering system, and a controller configured to determine a wheel slip of at least one road wheel of the vehicle, and in response to the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

Example 2 includes the vehicle of example 1, wherein in response to the wheel slip exceeding the wheel slip threshold, the controller is further configured to cause an increase of length of at least a portion of an active suspension system of the vehicle.

Example 3 includes the vehicle of example 2, wherein the controller is further configured to cause the increase of length of at least the portion of the active suspension system based on a chassis position of the vehicle relative to a surface on which the vehicle is traveling.

Example 4 includes the apparatus of any one or more of examples 1-3, wherein in response to the wheel slip exceeding the wheel slip threshold, the controller is further configured to cause at least one of the first road wheel or the second road wheel to perform alternating rotational movements around a steering axle of the vehicle.

Example 5 includes the vehicle of example 4, wherein the alternating rotational movements are less than a predetermined rotation angle interval about the steering axle.

Example 6 includes the apparatus of any one or more of examples 1-5, wherein the wheel slip threshold is configurable based on at least one of a speed of the vehicle or a speed change of the vehicle.

Example 7 includes the apparatus of any one or more of examples 1-6, wherein the controller is further configured to cause the first road wheel to assume the toe-in position and the second road wheel to assume the toe-out position based on a determination that the vehicle is operating in an off-road environment.

Example 8 includes the apparatus of any one or more of examples 1-7, wherein the controller is further configured to generate a notification to a user interface of the vehicle based on the wheel slip exceeding the wheel slip threshold.

Example 9 includes a non-transitory machine readable storage medium comprising instructions to cause programmable circuitry to at least determine a wheel slip of at least one road wheel of a vehicle, and based on the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

Example 10 includes the non-transitory machine readable storage medium of example 9, wherein based on the wheel slip exceeding the wheel slip threshold, the programmable circuitry is to cause an increase of length to at least a portion of an active suspension system of the vehicle.

Example 11 includes the non-transitory machine readable medium of example 10, wherein the programmable circuitry is to cause the increase of length of at least the portion of the active suspension system based on a chassis position of the vehicle relative to a surface on which the vehicle is traveling.
Example 12 includes the non-transitory machine readable medium of example 9, wherein based on the wheel slip exceeding the wheel slip threshold, the programmable circuitry is to cause at least one of the first road wheel or the second road wheel to perform alternating rotational movements around a steering axle of the vehicle.
Example 13 includes the non-transitory machine readable medium of example 12, wherein the alternating rotational movements are less than a predetermined rotation angle interval about the steering axle.
Example 14 includes the apparatus of any one or more of examples 9-13, wherein the wheel slip threshold is configurable based on at least one of a speed of the vehicle or a speed change of the vehicle.
Example 15 includes the apparatus of any one or more of examples 9-14, wherein the programmable circuitry is to cause the first road wheel to assume the toe-in position and the second road wheel to assume the toe-out position based on a determination that the vehicle is operating in an off-road environment.
Example 16 includes the apparatus of any one or more of examples 9-15, programmable circuitry is to generate a notification to a user interface of the vehicle based on the wheel slip exceeding the wheel slip threshold.
Example 17 includes a method comprising determining a wheel slip of at least one road wheel of a vehicle, and based on the wheel slip exceeding a wheel slip threshold, causing a first road wheel of the vehicle to assume a toe-in position relative to a track position of the vehicle, and causing a second road wheel of the vehicle to assume a toe-out position relative to the track position of the vehicle.
Example 18 includes the method of example 17, wherein based on the wheel slip exceeding the wheel slip threshold, further including causing an increase of length to at least a portion of an active suspension component of the vehicle.

Example 19 includes the method of any one or more of examples 17-18, wherein based on the wheel slip exceeding the wheel slip threshold, further including causing at least one of the first road wheel or the second road wheel to perform alternating rotational movements around a steering axle of the vehicle.

Example 20 includes the method of any one or more of examples 17-19, wherein causing the first road wheel of the vehicle to assume the toe-in position and causing the second road wheel to assume the toe-out position is further based on a determination that the vehicle is operating in an off-road environment.

What is claimed is:

1. A vehicle comprising:
an active suspension system;
an electric steering system; and
a controller configured to:
determine a wheel slip of at least one road wheel of the vehicle; and
in response to the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

2. The vehicle of claim 1, wherein in response to the wheel slip exceeding the wheel slip threshold, the controller is further configured to cause an increase of length of at least a portion of an active suspension system of the vehicle.

3. The vehicle of claim 2, wherein the controller is further configured to cause the increase of length of at least the portion of the active suspension system based on a chassis position of the vehicle relative to a surface on which the vehicle is traveling.

4. The vehicle of claim 1, wherein in response to the wheel slip exceeding the wheel slip threshold, the controller is further configured to cause at least one of the first road wheel or the second road wheel to perform alternating rotational movements around a steering axle of the vehicle.

5. The vehicle of claim 4, wherein the alternating rotational movements are less than a predetermined rotation angle interval about the steering axle.

6. The vehicle of claim 1, wherein the wheel slip threshold is configurable based on at least one of a speed of the vehicle or a speed change of the vehicle.

7. The vehicle of claim 1, wherein the controller is further configured to cause the first road wheel to assume the toe-in position and the second road wheel to assume the toe-out position based on a determination that the vehicle is operating in an off-road environment.

8. The vehicle of claim 1, wherein the controller is further configured to generate a notification to a user interface of the vehicle based on the wheel slip exceeding the wheel slip threshold.

9. A non-transitory machine readable storage medium comprising instructions to cause programmable circuitry to at least:
determine a wheel slip of at least one road wheel of a vehicle; and
based on the wheel slip exceeding a wheel slip threshold, cause a first road wheel of the vehicle to assume a toe-in position relative to a track position of the vehicle, and cause a second road wheel of the vehicle to assume a toe-out position relative to the track position of the vehicle.

10. The non-transitory machine readable storage medium of claim 9, wherein based on the wheel slip exceeding the wheel slip threshold, the programmable circuitry is to cause an increase of length to at least a portion of an active suspension system of the vehicle.

11. The non-transitory machine readable medium of claim 10, wherein the programmable circuitry is to cause the increase of length of at least the portion of the active suspension system based on a chassis position of the vehicle relative to a surface on which the vehicle is traveling.

12. The non-transitory machine readable medium of claim 9, wherein based on the wheel slip exceeding the wheel slip threshold, the programmable circuitry is to cause at least one of the first road wheel or the second road wheel to perform alternating rotational movements around a steering axle of the vehicle.

13. The non-transitory machine readable medium of claim 12, wherein the alternating rotational movements are less than a predetermined rotation angle interval about the steering axle.

14. The non-transitory machine readable medium of claim 9, wherein the wheel slip threshold is configurable based on at least one of a speed of the vehicle or a speed change of the vehicle.

15. The non-transitory machine readable medium of claim 9, wherein the programmable circuitry is to cause the first road wheel to assume the toe-in position and the second road wheel to assume the toe-out position based on a determination that the vehicle is operating in an off-road environment.

16. The non-transitory machine readable medium of claim 9, programmable circuitry is to generate a notification to a user interface of the vehicle based on the wheel slip exceeding the wheel slip threshold.

17. A method comprising:
determining a wheel slip of at least one road wheel of a vehicle; and
based on the wheel slip exceeding a wheel slip threshold, causing a first road wheel of the vehicle to assume a toe-in position relative to a track position of the vehicle, and causing a second road wheel of the vehicle to assume a toe-out position relative to the track position of the vehicle.

18. The method of claim 17, wherein based on the wheel slip exceeding the wheel slip threshold, further including causing an increase of length to at least a portion of an active suspension component of the vehicle.

19. The method of claim 17, wherein based on the wheel slip exceeding the wheel slip threshold, further including causing at least one of the first road wheel or the second road wheel to perform alternating rotational movements around a steering axle of the vehicle.

20. The method of claim 17, wherein causing the first road wheel of the vehicle to assume the toe-in position and causing the second road wheel to assume the toe-out position is further based on a determination that the vehicle is operating in an off-road environment.
